(19) United States
(12) Patent Application Publication
(10) Pub. No.: US 2026/0189095 A1
(43) Pub. Date: Jul. 2, 2026

(54) STATOR

(71) Applicant: TOYOTA JIDOSHA KABUSHIKI KAISHA, Toyota-shi (JP)

(72) Inventors: Kohei WATANABE, Okazaki-shi (JP); Hiroaki URANO, Miyoshi-shi (JP); Junichi DEGUCHI, Toyota-shi (JP); Jun KAWAKAMI, Nishio-shi (JP); Naohiro NAGASAWA, Okazaki-shi (JP); Yuki TANAKA, Nagakute-shi (JP); Norihiro USHIDA, Numazu-shi (JP)

(73) Assignee: TOYOTA JIDOSHA KABUSHIKI KAISHA, Toyota-shi (JP)

(21) Appl. No.: 19/426,536

(22) Filed: Dec. 19, 2025

(30) Foreign Application Priority Data
Dec. 27, 2024 (JP) 2024-232193

(51) Int. Cl. H02K 3/34; H02K 3/16; H02K 15/108; H02K 15/35

(52) U.S. Cl. CPC H02K 3/345; H02K 3/16; H02K 15/108; H02K 15/35

(57) ABSTRACT

A stator includes: a stator core; a coil attached to the stator core in a state in which a part of the coil is inserted into a slot provided in the stator core; and insulating paper configured to insulate the stator core and the coil, the insulating paper being inserted into the slot, in which a first surface of the coil includes a recessed portion in a range facing a corner of an opening portion of the slot on an end surface facing an axial direction of the stator core, the first surface facing a direction in which a coil end portion protruding from the end surface is bent.

### CROSS-REFERENCE TO RELATED APPLICATION

This application claims priority to Japanese Patent Application No. 2024-232193 filed on Dec. 27, 2024. The disclosure of the above-identified application, including the specification, drawings, and claims, is incorporated by reference herein in its entirety.

### BACKGROUND

### 1. Technical Field

The technique disclosed in the present specification relates to a stator.

### 2. Description of Related Art

Japanese Unexamined Patent Application Publication No. 2022-143986 discloses that a straight portion of a belt-shaped coil wound in an annular shape is inserted into a slot having insulating paper from the inside of a stator core. Accordingly, mounting the belt-shaped coil along a circumferential direction of the stator core is disclosed.

### SUMMARY

When a stator is manufactured by attaching a coil to the stator core, a coil end portion that is a portion protruding from an end surface of the stator core is processed by bending. When bending of the coil applies stress to the stator core, a part of the stator core may be damaged, leading to energy loss in a motor that includes the stator as a constituent component. In the related art, in such a state, a method has been employed in which a specific jig is disposed in the vicinity of a base of the coil end portion to reduce the stress transmitted to the stator core due to bending of the coil.

However, according to the method, a problem occurs in that a height of the coil end portion from the end surface of the stator core increases in order to secure a space for disposing the jig in the vicinity of the base of the coil end portion. In addition, the cost of manufacturing the stator increases due to the use of the jig described above.

The present specification discloses a stator.

The stator includes:
a stator core;
a coil attached to the stator core in a state in which a part of the coil is inserted into a slot provided in the stator core; and
insulating paper configured to insulate the stator core and the coil, the insulating paper being inserted into the slot.
   With the stator, a first surface that is a surface of the coil includes a recessed portion in a range facing a corner of an opening portion of the slot on an end surface facing an axial direction of the stator core, the first surface facing a direction in which a coil end portion protruding from the end surface is bent.

According to the configuration, since the first surface of the coil includes the recessed portion, the stress applied to the stator core due to bending of the coil end portion is reduced. Accordingly, the disadvantages caused by using the jig in the related art can be avoided, and the stress applied to the stator core can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a structure of a stator;

FIG. 2 is a diagram schematically showing an outline of an assembling method of the stator;

FIG. 3 is a flowchart showing the assembling method of the stator;

FIG. 4 is a perspective view showing a part of the stator from a second end surface side;

FIG. 5 is a view showing one slot from a viewpoint facing the second end surface; and

FIG. 6 is a cross-sectional view taken along a line VI-VI of FIG. 5.

### DETAILED DESCRIPTION OF EMBODIMENTS

The main features of the embodiment to be described below will be listed. These features can be combined in any desired manner.

According to the stator disclosed in the present specification, the first surface and the corner of the opening portion may not be in contact with each other in a state in which the coil end portion is bent.
According to the configuration, since the first surface of the coil includes the recessed portion, the first surface and the corner of the opening portion are not in contact with each other in a state in which the coil end portion is bent. Therefore, the application of stress to the stator core due to bending of the coil end portion is avoided.

According to the stator disclosed in the present specification, the end portion of the insulating paper may protrude from the end surface and cover at least a part of the recessed portion.

According to the configuration, even in a case in which, due to bending of the coil end portion, the recessed portion on the first surface of the coil and the corner of the opening portion come close enough to each other to the extent of being in contact, the insulation between the two closely positioned portions is ensured by the insulating paper.

According to the stator disclosed in the present specification, the coil is configured by connecting a plurality of segment coils. The slot is provided to extend in a radial direction of the stator core. A predetermined number of the segment coils are inserted into the slot in a state of being arranged along the radial direction. The first surface of each of the segment coils includes the recessed portion. The coil end portion of each of the segment coils may be bent in a direction intersecting the radial direction. According to the configuration, since the first surface of each of the segment coils includes the recessed portion, the stress applied to the stator core due to bending of the coil end portion of each of the segment coils is reduced.

The present embodiment will be described with reference to the drawings. Each of the drawings is merely an example, and the present embodiment is not limited to the content shown in the drawings. In addition, since each of the drawings is an example, a part of the content may be omitted.

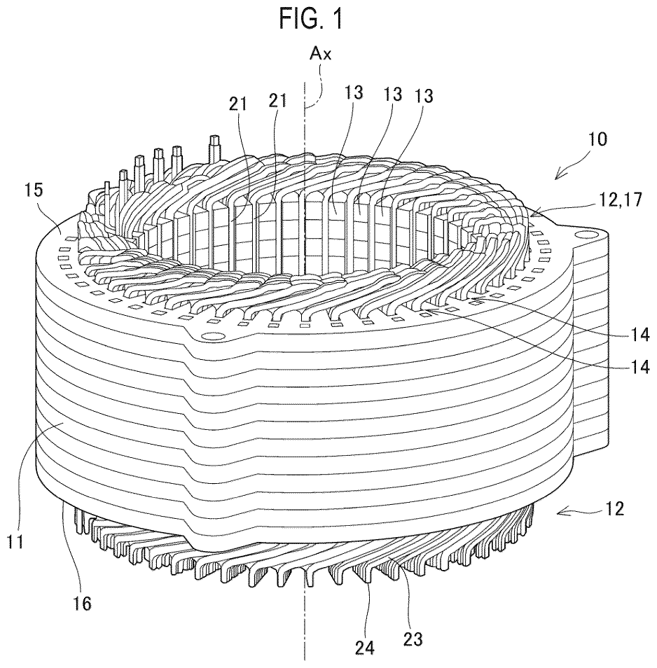

FIG. 1 schematically shows a structure of a stator 10 in a perspective view. The stator 10 generally includes a stator core 11 and a coil 12. The stator 10 is a constituent component of a motor that is driven by electric power. The concept of the motor includes various motors, such as a direct current (DC) motor, an alternating current (AC) motor, a stepping motor, and a servo motor.

A specific configuration or material of the stator core 11 is not particularly limited. For example, the stator core 11 has a substantially tubular shape, and is configured by laminating a plurality of silicon steel plates. Hereinafter, the radial direction of the stator core 11, the circumferential direction of the stator core 11, and the axial direction of the stator core 11 are simply referred to as a radial direction, a circumferential direction, and an axial direction, respectively. The axial direction is a direction parallel to a center axis Ax of the stator core 11. The radial direction is a direction that intersects the center axis Ax perpendicularly and extends radially from the center axis Ax. In the radial direction, a side closer to the center axis Ax is radially inward, and a side farther from the center axis Ax is radially outward.

On the inner circumference of the stator core 11, a plurality of tooth portions 13 protrude radially inward. The tooth portions 13 are arranged along the circumferential direction. Each gap between the tooth portions 13 adjacent to each other in the circumferential direction is referred to as a slot 14. All of the plurality of slots 14 provided in the stator core 11 are open to an inner circumferential surface and both end surfaces of the stator core 11 facing the axial direction. One end surface of the stator core 11 facing the axial direction is referred to as a first end surface 15, and the other end surface of the stator core 11 facing the axial direction is referred to as a second end surface 16.

The coil 12 is attached to the stator core 11 in a state in which a part of the coil 12 is inserted into each of the slots 14 of the stator core 11. It may also be said that the coil 12 is wound around the tooth portions 13 and extends along the circumferential direction. The coil 12 corresponds to, for example, each of three-phase coils corresponding to a three-phase alternating current voltage, that is, three coils corresponding to U-phase, V-phase, and W-phase. Electric power is supplied from an inverter (not shown) outside the stator 10 to such a coil 12.

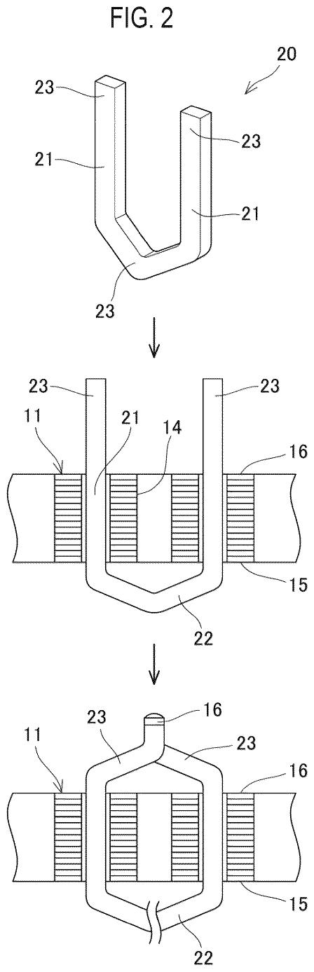

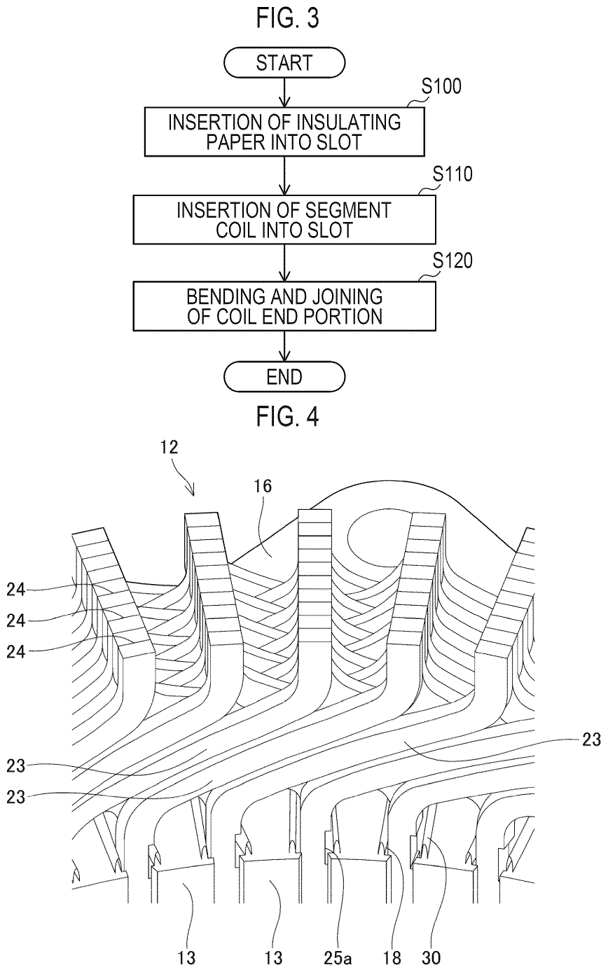

FIG. 2 schematically shows an outline of a method of assembling the stator 10. FIG. 3 shows a method of assembling the stator 10 in a flowchart. In an upper part of FIG. 2, a segment coil 20 that is a unit constituting the coil 12 is schematically shown. The segment coil 20 has a generally U-shape and includes two lead portions 21 and a curved portion 22 that connects the two lead portions 21. The lead portion 21 may be referred to as, for example, a straight portion. The curved portion 22 may be referred to as, for example, a reverse lead portion. The segment coil 20 is provided by, for example, bending processing of a flat wire conductor having a rectangular cross-sectional shape. Although not shown in FIG. 2, a crank portion may be provided in, for example, the vicinity of the center of the curved portion 22 to change lanes between the first lead portion 21 and the second lead portion 21. Reference numeral 23 denotes a coil end portion 23 that is a portion on a tip end side of each lead portion 21.

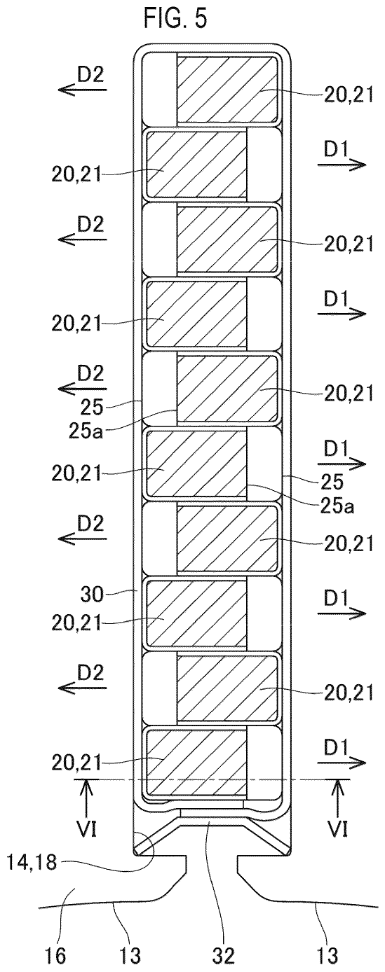

In S100, the insulating paper is inserted into the stator core 11. That is, insulating paper 30 (see FIG. 5 and the like) is inserted into the slot 14 of the stator core 11. The insulating paper 30 is inserted to insulate the stator core 11 and the coil 12. The insulating paper 30 is a sheet-like insulating material having insulating properties and flexibility. The insulating paper 30 is also referred to as a multilayer laminate material or the like. A method of inserting the insulating paper 30 into the slot 14 is not particularly limited. The insulating paper 30 is inserted into the slot 14, for example, through an opening portion of the slot 14 provided on the first end surface 15 or through an opening portion 18 of the slot 14 provided on the second end surface 16. Alternatively, the insulating paper 30 may be inserted into the slot 14 from the inner circumferential surface side of the stator core 11. S100 corresponds to an example of an “insulating paper insertion step”.

In S110, the segment coil 20 is inserted into the slot 14 of the stator core 11, inside the insulating paper 30. In a middle part and a lower part of FIG. 2, a part of the stator core 11 is shown from the inner circumferential surface side. As shown in the middle part of FIG. 2, the segment coil 20 is inserted from the side of the first end surface 15 of the stator core 11, with its lead portion 21 that is a part of the coil 12 inserted into the slot 14. The two lead portions 21 included in one segment coil 20 are inserted into different slots 14. As a result, the segment coil 20 is in a state in which the curved portion 22 protrudes from the first end surface 15 and the coil end portions 23 protrude from the second end surface 16. In FIG. 2, the insulating paper 30 is not shown. S110 corresponds to an example of a “coil insertion step”.

In S120, the coil end portions 23 protruding from the second end surface 16 of the stator core 11 are subjected to bending and joining. The concept of bending may be understood to include a process of twisting an object. The coil end portions 23 are straight when the coil end portions 23 are inserted from the first end surface 15 side and protrude from the second end surface 16. The coil end portions 23 are each appropriately bent or twisted in the circumferential direction or the radial direction, and, as shown in a lower part of FIG. 2, are joined to the coil end portions 23 of other segment coils 20 by welding or the like. S120 corresponds to an example of a “bending step”.

A portion where different segment coils 20 are joined to each other at their coil end portions 23 is referred to as a joining portion 24. A plurality of segment coils 20 inserted into the stator core 11 are joined to each other at their coil end portions 23, thereby providing a continuous coil 12 (for example, a coil 12 corresponding to a U phase). That is, the coil 12 is configured by connecting the segment coils 20.

FIG. 4 shows a part of the stator 10 from the second end surface 16 side in a perspective view. FIG. 4 shows a plurality of the joining portions 24 where the bent coil end portions 23 are joined to each other. In S110, the segment coils 20, annularly aligned by, for example, a known annular alignment method, are inserted into respective slots 14 of the stator core 11 from the first end surface 15 side. On the second end surface 16 side, the method of connecting the segment coils 20, such as which coil end portions 23 are connected to each other and in what positional relationship, is not specifically described in the present embodiment, as various connection patterns have been proposed. The method of assembling the stator 10 may further include one or more steps not shown in FIG. 3.

FIG. 5 shows one slot 14, together with the insulating paper 30 and the segment coils 20 inserted into the slot 14, from a viewpoint facing the second end surface 16 of the stator core 11. The opening portion 18 of the slot 14 is provided on the second end surface 16. The slot 14 extends radially outward from the inner circumferential surface of the stator core 11. That is, the slot 14 is provided to extend in the radial direction. A predetermined number (ten in FIG. 5) of the segment coils 20 are inserted into the slot 14 in a state of being arranged along the radial direction. In FIG. 5, a cross section of each of the segment coils 20 inserted into the slot 14 is shown. The cross section of each of the segment coils 20 may be understood as a cross section of each of the lead portions 21 or each of the coil end portions 23 of each of the segment coils 20. In FIG. 5, the segment coils 20 that appear to be adjacent and in contact with each other are insulated from each other except at the joining portions 24.

According to FIG. 5, the insulating paper 30 is accommodated in the slot 14 to collectively surround the predetermined number of segment coils 20. FIG. 4 also schematically shows the opening portion 18 of the slot 14 and the insulating paper 30. In the example of FIG. 5, the wedge paper 32 is inserted into the slot 14 at a radially innermost position. The wedge paper 32 is retained by being braced between projections provided at the tip ends of the tooth portions 13 on both sides of the slot 14, the projections protruding into the slot 14. The wedge paper 32 has a function of pressing the tip end of the bent insulating paper 30 and serves as a spacer that eliminates the gap in the slot 14.

In FIG. 5, directions (bending directions) D1 and D2 in which the coil end portions 23 are bent in S120 for each of the segment coils 20 arranged in the slot 14 in the radial direction are shown. Both the bending direction D1 and the bending direction D2 are directions intersecting the radial direction and are in opposite directions to each other. In addition, both the bending direction D1 and the bending direction D2 can be said to be substantially along the circumferential direction. According to FIG. 5, each of the segment coils 20 arranged in the radial direction in the slot 14 has its coil end portions 23 alternately bent in the bending direction D1 and the bending direction D2.

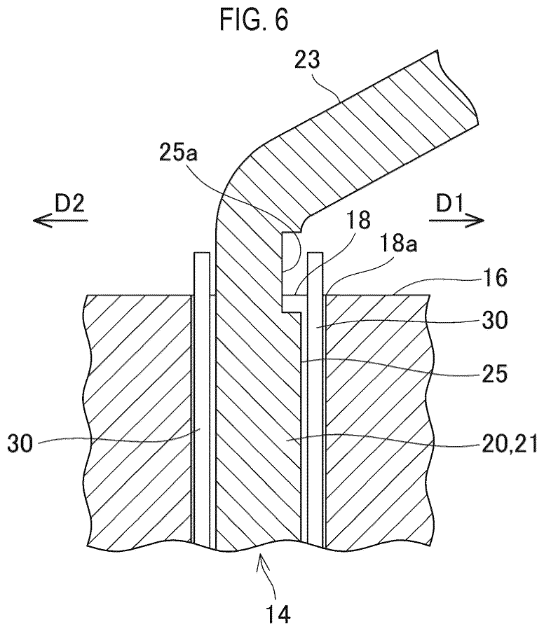

FIG. 6 shows a cross section taken along a line VI-VI of FIG. 5. However, in FIG. 6, hatching is not applied to the cross section of the insulating paper 30 in consideration of visibility. In the segment coil 20 shown in FIG. 6, the coil end portion 23 is bent in the bending direction D1. A surface of the coil 12 facing the bending direction of the coil end portion 23 is referred to as a “first surface 25”. When the coil end portion 23 is the lead portion 21 that is bent in the bending direction D1, a surface facing the bending direction D1 corresponds to the first surface 25. On the other hand, when the coil end portion 23 is the lead portion 21 that is bent in the bending direction D2, a surface facing the bending direction D2 corresponds to the first surface 25.

As shown in FIGS. 5 and 6, the first surface 25 includes a recessed portion 25a in a range facing the corner 18a of the opening portion 18 on the second end surface 16. The recessed portion 25a is open in the bending direction of the coil end portion 23, radially inward, and radially outward. The recessed portion 25a increases a distance between the first surface 25 and the corner 18a of the opening portion 18. As can be seen from FIG. 5, the first surface 25 of each of the segment coils 20 inserted into the slot 14 includes a recessed portion 25a.

According to FIG. 6, a cross-sectional shape of the recessed portion 25a perpendicular to the radial direction is rectangular, but the shape of the recessed portion 25a is not limited to the illustrated example. The shape of the recessed portion 25a may be, for example, a shape obtained by cutting a part of the first surface 25 in a V-shape, a semicircular shape, a trapezoidal shape, or another polygonal shape. It should be noted that the recessed portion 25a is also shown in FIG. 4.

According to such a configuration, since the first surface 25 of the coil 12 includes the recessed portion 25a, the stress applied to the stator core 11 due to bending of the coil end portion 23 is reduced without using a jig in the related art. As shown in FIG. 6, even in a state in which the coil end portion 23 is bent, the first surface 25 and the corner 18a of the opening portion 18 are not in contact with each other because the recessed portion 25a is positioned between the first surface 25 and the corner 18a of the opening portion 18. Therefore, the application of stress to the stator core 11 due to bending of the coil end portion 23 is avoided. Alternatively, the coil end portion 23 may be bent to the extent that the recessed portion 25a presses against the corner 18a of the opening portion 18. Even in this case, compared to a case in which the recessed portion 25a is not provided, the stress transmitted from the segment coil 20 to the stator core 11 when the coil end portion 23 is bent is reduced. In the present specification, the reduction of the stress applied to the stator core 11 includes both cases where the stress is reduced and where the stress becomes substantially zero.

As shown in FIG. 6, an end portion of the insulating paper 30 may protrude from the second end surface 16. The end portion of the insulating paper 30 protruding from the second end surface 16 may be bent, as in the example in FIG. 4. The end portion of the insulating paper 30 protruding from the second end surface 16 may cover at least a part of the recessed portion 25a. According to FIG. 6, with respect to the opening of the recessed portion 25a facing the bending direction D1, a range within the stator core 11 is entirely covered with the insulating paper 30, and a range outside the stator core 11 is partially or entirely covered with the insulating paper 30. Since the recessed portion 25a is covered with the insulating paper 30, even in a case in which the recessed portion 25a of the first surface 25 and the corner 18a of the opening portion 18 come close enough to each other to the extent of being in contact, the insulation between the two closely positioned portions is ensured by the insulating paper 30. In addition, due to the cushioning property of the insulating paper 30, the stress transmitted from the coil 12 to the stator core 11 is reduced. A configuration in which the insulating paper 30 does not protrude from the second end surface 16 or the first end surface 15 of the stator core 11 is also within the scope of the disclosure of the present specification.

Although specific examples of the technique disclosed in the present specification have been described in detail above, these examples are merely illustrative and do not limit the scope of the claims. The technique described in the claims includes various modifications and changes of the specific examples illustrated above. In addition, the technical elements described in the present specification or the drawings exhibit technical usefulness alone or in various combinations and are not limited to the combinations described in the claims at the time of filing. Further, the technique exemplified in the present specification or the drawings achieves a plurality of objectives at the same time, and achieving one of the objectives has technical usefulness.

What is claimed is:

1. A stator comprising:
a stator core;
a coil attached to the stator core in a state in which a part of the coil is inserted into a slot provided in the stator core; and
insulating paper configured to insulate the stator core and the coil, the insulating paper being inserted into the slot, wherein a first surface of the coil includes a recessed portion in a range facing a corner of an opening portion of the slot on an end surface facing an axial direction of the stator core, the first surface facing a direction in which a coil end portion protruding from the end surface is bent.

2. The stator according to claim 1, wherein the first surface and the corner of the opening portion are not in contact with each other in a state in which the coil end portion is bent.

3. The stator according to claim 1, wherein an end portion of the insulating paper protrudes from the end surface and covers at least a part of the recessed portion.

4. The stator according to claim 1, wherein:
the coil is configured by connecting a plurality of segment coils;
the slot is provided to extend in a radial direction of the stator core;
a predetermined number of the segment coils are inserted into the slot in a state of being arranged along the radial direction;
the first surface of each of the segment coils includes the recessed portion; and
the coil end portion of each of the segment coils is bent in a direction intersecting the radial direction.
